(19) United States
(12) Patent Application Publication
(10) Pub. No.: US 2024/0004188 A1
(43) Pub. Date: Jan. 4, 2024

(54) SPINNING LENS

(71) Applicant: Vay Technology GmbH, Berlin (DE)

(72) Inventors: Harsh Shah, Berlin (DE); James Heath, Berlin (DE)

(21) Appl. No.: 17/855,478

(22) Filed: Jun. 30, 2022

(51) Int. Cl. G02B 27/00; B60S 1/56; B60R 11/04

(52) U.S. Cl. CPC G02B 27/0006; B60S 1/56; B60R 11/04

(57) ABSTRACT

Described is a system, method, and apparatus that removes substances (e.g., water) from a field of view of an imaging element so that the objects within the field of view are not obstructed or obscured from the perspective of the imaging element and do not appear obstructed or obscured in the image data generated by the imaging element. Implementations include an apparatus that has housing that includes a base surface and a perimeter that, when coupled together, form an interior. The perimeter surface may include a substantially cylindrical opening through which a field of view of an imaging element positioned within the interior of the housing may be oriented. A spinning lens assembly may be positioned within the substantially cylindrical opening and rotatable by a motor such that, when rotated, any substance on a surface of the lens is evacuated from the surface of the lens.

### BACKGROUND

As vehicles transition from being driven and manually operated by drivers located in the vehicle to partially autonomous vehicles, fully autonomous vehicles, and/or teledriven vehicles in when an operator at a remote location controls and drives the vehicle, safe operation of those vehicles has become more reliant on image data that is representative of the environment surrounding the vehicle. For example, many vehicles are now equipped with cameras that capture image data of the environment surrounding the vehicle. However, if a substance, such as water, dirt, moisture, snow, etc., comes into the contact with the lens of the camera as the image data is generated, the objects represented in the image data may be obstructed and/or obscured, thereby making reliance on that image data unsafe.

### BRIEF DESCRIPTION OF DRAWINGS

The detailed description is described with reference to the accompanying figures.

FIG. 1 is an example diagram of a system that includes a vehicle with one or more apparatus and a teledriving system, in accordance with described implementations.

FIGS. 2A and 2B are example illustrations of an apparatus, in accordance with described implementations.

FIG. 3 is an example illustration of an interior of an apparatus that includes a motor, an imaging element, and a spinning lens assembly that is rotated using one or more pullies, in accordance with described implementations.

FIG. 4 is an example side sectional view of an example apparatus that includes a motor, an imaging element, and a spinning lens assembly that is rotated using one or more pullies, in accordance with described implementations.

FIG. 5 is another example side sectional view of an example apparatus that includes a motor, an imaging element, and a spinning lens assembly that is rotated using one or more pullies, in accordance with described implementations.

FIG. 6 is another example illustration of an interior of an apparatus that includes a motor, an imaging element, and a spinning lens assembly that is rotated using one or more gears, in accordance with described implementations.

FIG. 7 is another side sectional view of an example apparatus in which the imaging element is positioned within an interior of a motor that rotates a spinning lens assembly of the apparatus, in accordance with described implementations.

FIG. 8A is an example out-runner brushless direct current motor with an encompassed imaging element, in accordance with described implementations.

FIG. 8B is an example in-runner brushless direct current motor with an encompassed imaging element, in accordance with described implementations.

FIG. 9 is an example spinning lens process, in accordance with described implementations.

### DETAILED DESCRIPTION

Described are systems, methods, and apparatus that removes substances, such as water, ice, snow, dust, dirt, mud, etc., from a field of view of an imaging element so that the objects within the field of view of the imaging element are not obstructed or obscured from the perspective of the imaging element and do not appear obstructed or obscured in the image data generated by the imaging element. As discussed below, implementations include an apparatus that has housing that includes a base surface and a perimeter surface that, when coupled together, form an interior. The base surface may be configured so that it is attachable to a vehicle, such as an automobile. The perimeter surface may include a substantially cylindrical opening through which a field of view of an imaging element positioned within the interior of the housing may be oriented. A spinning lens assembly may be positioned within the substantially cylindrical opening of the perimeter surface and rotatable by a motor such that, when rotated, any substance on a surface of a lens of the spinning lens assembly is evacuated from the surface of the lens. For example, the spinning lens assembly may be coupled to, or rotatable by a motor such that the spinning lens assembly will rotate at a revolutions per minute (“RPM”) that is sufficient to cause any substance on a surface of a lens of the spinning lens assembly to be evacuated from the lens as a result of the centrifugal forces caused by the rotation of the spinning lens assembly.

In some implementations, the motor may be activated in response to a signal from a sensor, such as a moisture sensor, that is included in the apparatus and/or attached to the vehicle. In other implementations, the motor may be activated in response to a signal from a switch (electrical, mechanical, electro-mechanical, software, etc.). The switch may be included in the vehicle and/or remote from the vehicle. For example, as discussed below, in implementations in which the image data from the imaging element included in the apparatus is transmitted from the vehicle to a remote teledriving system, the remote teledriving system may include a switch that may be activated by a teledriver positioned at the remote teledriving system. In still other examples, image processing of image data generated by the imaging element included in the apparatus may be performed to determine if potential substances on the lens of the spinning lens assembly are causing obstructions or obfuscations that are represented in the image. If the image analysis determines that substances are potentially present on the surface of the lens of the spinning lens assembly, a signal may be sent to the motor of the apparatus to activate the motor and rotate the spinning lens assembly. In yet another example, the apparatus may be configured to rotate the spinning lens assembly when the vehicle is operational and/or in motion.

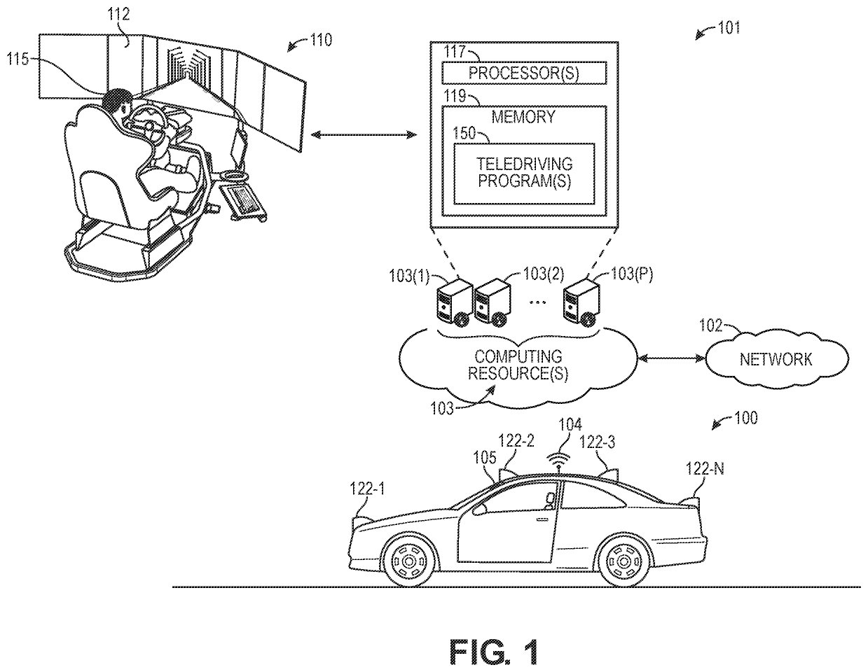

FIG. 1 is an example diagram of a system 101 that includes vehicle 100 with one or more apparatus 122-1, 122-2, 122-3, through 122-N and a teledriving system 110, in accordance with described implementations.

In the example illustration, the vehicle 100 is an automobile that may be controlled or driven by an operator 115 at the teledriving system 110. As such, the vehicle 100 may be occupied, for example by a passenger, or unoccupied but still operational through control of the operator 115. In other implementations, the vehicle may be operated by a driver that is local to the vehicle and/or the vehicle may be partially or fully autonomous. Regardless of whether the vehicle 100 is fully autonomous, partially autonomous, teledriven by an operator 115, locally driving by a driver within the vehicle 100, other otherwise, image data from one or more imaging elements positioned within an apparatus 122-1 through 122-N may be utilized. For example, if the vehicle 100 is teledriven by an operator 115, image data generated by imaging elements positioned within the apparatus 122-1 through 122-N that are affixed to the vehicle may be wirelessly transmitted from an antenna 104 coupled to the vehicle 100 and presented on display 112 at the teledriving system 110 so that the operator 115 can safely operate the vehicle 100. For example, the image data generated by the one or more imaging elements of the apparatus 122-1 through 122-N of the vehicle 100 may be wirelessly transmitted from the antenna 104 of the vehicle to one or more computing resources 103 via a network 102, such as the Internet. The computing resources 103, which may include the teledriving program(s) 150 that cause image data to be sent for presentation on the displays 112, send instructions from the teledriving system 110 to the vehicle 100, etc., may be remote from both the teledriving system 110 and the vehicle 100, may be local to the teledriving system 110, and/or local to the vehicle 100.

In examples in which the vehicle is autonomous, image data from the one or more apparatus 122-1 through 122-N may be sent to computing systems that control the vehicle 100 for processing by those systems. In such implementations, the computing systems that control the vehicle 100 may be local to the vehicle 100 or remote from the vehicle 100.

Any number of apparatus 122-1 through 122-N may be coupled to the vehicle 100 and positioned at any different orientation. For example, a first apparatus 122-1 may be coupled to a hood or front of the vehicle 100 and oriented such that the field of view of the imaging element of the apparatus 122-1 is oriented in the forward direction of the vehicle, also referred to herein as zero degrees of three hundred and sixty degrees around the vehicle. A second apparatus 122-2 may be positioned on a roof or top of the vehicle and oriented such that the field of view of the apparatus 122-2 is oriented at a first degree (e.g., thirty degrees) with respect to the forward or zero degree of the vehicle. Likewise, a third apparatus 122-3 may be positioned at another location on the vehicle 100 and oriented such that a field of view of the imaging element included in the apparatus 122-3 is oriented in a second degree (e.g., seventy-five degrees) with respect to the forward or zero degree of the vehicle. As will be appreciated, any number of apparatus may be coupled to the vehicle at any location on the vehicle and oriented in any direction.

The imaging element, as used herein, may be any form of digital imaging element, such as a two-dimensional visible light camera, a stereo or three-dimensional visible light camera, a light detection and ranging (“LIDAR”) element, an infrared imaging element, etc., and/or any combination thereof.

As discussed further below, the vehicle and/or apparatus may include a sensor, such as a moisture sensor that, upon detection of a substance that may potentially contact the lens of the spinning lens assembly of the apparatus, may send a signal to the apparatus that causes the motor to engage and rotate the spinning lens assembly. Alternatively, or in addition thereto, a switch may be included in the vehicle and/or remote from the vehicle (e.g., at the teledriving system) that, when activated, sends a signal that causes the motor of the apparatus to engage.

While the examples discussed herein are directed toward a vehicle in the form of an automobile, the disclosed implementations are equally applicable to other types of land based vehicles, water based vehicles, and/or air based vehicles and the automobile/vehicles discussed herein are provided for explanation purposes only.

The system 101 may also include computing resource(s) 103. The computing resource(s) 103 may be local to the teledriving system, remote, or any combination thereof. Likewise, the computing resource(s) 103 may be configured to communicate over a network 102 with input/output components the vehicle 100 and/or apparatus 122 and/or with the teledriving system 110.

As illustrated, the computing resource(s) 103 may be implemented as one or more servers 103(1), 103(2), . . . , 103(P) and may, in some instances, form a portion of a network-accessible computing platform implemented as a computing infrastructure of processors, storage, software, data access, and so forth that is maintained and accessible by components/devices of the teledriving program(s) 150 via a network 102, such as the Internet. The computing resource(s) 103 do not require end-user knowledge of the physical location and configuration of the system that delivers the services. Common expressions associated for these remote computing resource(s) 103 include “on-demand computing,” “software as a service (SaaS),” “platform computing,” “network-accessible platform,” “cloud services,” “data centers,” and so forth.

Each of the servers 103(1)-(P) include one or more processors 117 and memory 119, which may store or otherwise have access to teledriving program(s) 150, which may include or provide control of the apparatus, process images, send image data for presentation on the displays 112 of the teledriving system 110, and/or send instructions to the vehicle, such as navigation or control instructions from the teledrive system 110 to the vehicle 100.

The network 102 may utilize wired technologies (e.g., wires, USB, fiber optic cable, etc.), wireless technologies (e.g., RF, IR, NFC, cellular, satellite, Bluetooth, etc.), or other connection technologies. The network 102 is representative of any type of communication network, including data and/or voice network, and may be implemented using wired infrastructure (e.g., cable, CAT6, fiber optic cable, etc.), a wireless infrastructure (e.g., RF, cellular, microwave, satellite, Bluetooth, etc.), and/or other connection technologies.

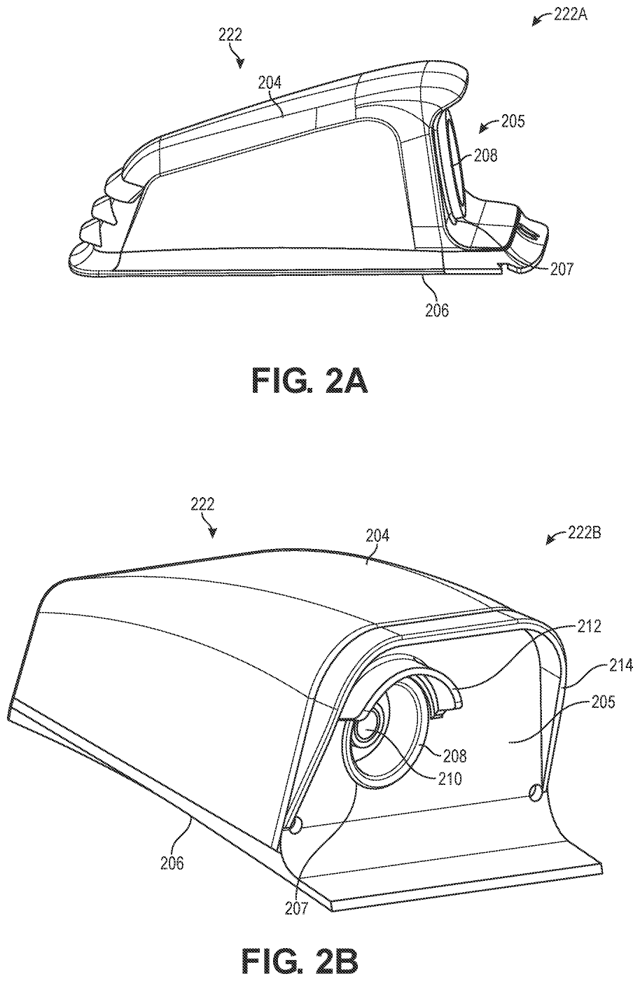

FIGS. 2A and 2B are example illustrations of an apparatus 222, in accordance with described implementations. FIG. 2A is a side view 222A of the apparatus 222 and FIG. 2B is a three-quarter view 222B of the apparatus 222.

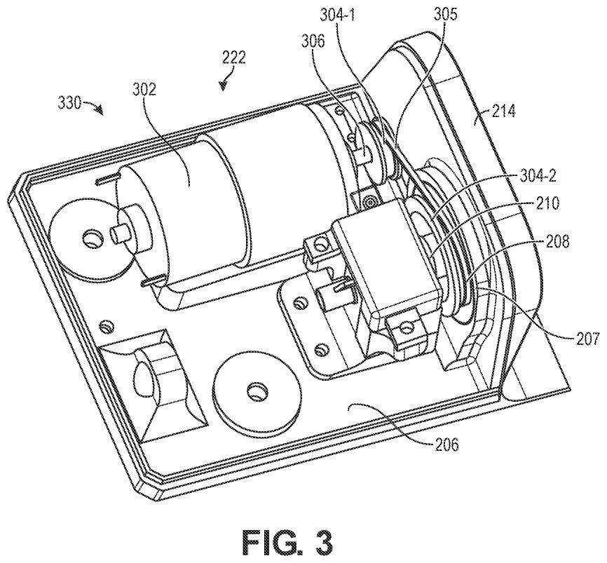

As illustrated in FIGS. 2A through 2B, the apparatus 222 includes a housing with a base surface 206 and a perimeter surface 204 that couples to the base surface 206 to form an interior within, which is discussed further below with respect to FIGS. 3 through 7. In some implementations, a rubber gasket may be positioned between the base surface 206 and the perimeter surface 204 to prohibit entry of water or other substances into the interior of the housing of the apparatus 222.

Also, as illustrated, the perimeter surface 204 includes a substantial circular opening 207 and a spinning lens assembly 208 is positioned within the substantially circular opening 207 and rotatable within the opening, as discussed further below. In some implementations, the perimeter surface 204 may include a face surface 205 that extends upward or away from the base surface 206. As illustrated, the substantially circular opening 207 of the perimeter surface 204 may be included in the face surface 205 and the spinning lens assembly 208 may be positioned within the substantially circular opening 207 so that the lens of the spinning lens assembly 208 is aligned approximately parallel or in-plane with the face surface 205.

In some implementations, the face surface 205 and the spinning lens assembly 208 may be approximately perpendicular to and extend from the base surface 206 when the perimeter surface 204 is coupled to the base surface. In other implementations, the face surface 205 and/or spinning lens assembly 208 may be pitched forward, backward and/or to one side with respect to the base surface 206. For example, and referring to FIG. 2A, the face surface 205 is illustrated such that the face surface 205 is pitched backward approximately five degrees from perpendicular with respect to the base surface 206. In other implementations, the face surface 205 and attached spinning lens assembly 208 may be pitched at a different angle. Alternatively, the face surface 205 may be pitched at a first angle with respect to the base surface 206 (or perpendicular to the base surface) and the spinning lens assembly 208 may be positioned within the substantially circular opening 207 so that it is pitched at a different angle with respect to the base surface 206 compared to the face surface 205.

In some implementations, the perimeter surface 204 may also include a primary hood 214 or shield that extends out from the face surface 205, is substantially perpendicular to the face surface 205, and positioned above at least a portion of the face surface 205. Optionally, or in addition thereto, a lens hood 212 that extends from the face surface 205 in a substantially perpendicular direction from the face surface 205 may also be included. The lens hood 212 may be positioned and end at least partially around the spinning lens assembly 208 and the substantially circular opening 207. Including a hood 214/212 and/or pitching the spinning lens assembly 208 and/or the face surface 205 may further aid in preventing substances, such as water, from contacting the lens of the spinning lens assembly 208. For example, if the car is stationary, the hoods 212/214 may block rain from contacting the lens. Likewise, if the spinning lens assembly 208 is pitched forward, the forward pitch may reduce the chance of rain contacting the lens of the spinning lens assembly 208 and through the lens 208A of the spinning lens assembly 208.

As illustrated in FIG. 2B, an imaging element 210 is positioned within the interior of the apparatus 222 and oriented such that a field of view of the imaging element 210 is through the substantially circular opening of the perimeter surface 204.

FIG. 3 is an example illustration of an interior 330 of an apparatus 222 that includes a motor 302, an imaging element 210, such as camera, and a spinning lens assembly 208 that is rotated using a pully drive mechanism, in accordance with described implementations.

The motor 302 is coupled to the base surface 206 such that the motor is within the interior 330 of the housing when the perimeter surface 204 is affixed to the base surface 206, as illustrated above with respect to FIGS. 2A and 2B. The motor 302 may be any type of motor that is operable to rotate a shaft 306. For example, the motor 302 may be a brushed direct current (“DC”) motor, a brushless DC motor, etc. In the illustrated implementation, a first rotating member 304-1, such as a pully, is coupled to the shaft 306 and rotates with the shaft 306 when the shaft 306 is rotated by the motor 302.

In the example illustrated with respect to FIG. 3, the imaging element 210 is affixed to the base surface 206 such that the imaging element 210 is positioned within the interior 330 of the housing when the perimeter surface 204 is affixed to the base surface 206, as illustrated above in FIGS. 2A and 2B. Likewise, the imaging element 210 is affixed to the base surface 206 of the apparatus 222 such that a field of view of the imaging element 210 extends through the substantially circular opening 207 and through the spinning lens assembly 208 that is rotatably positioned within the substantially circular opening 207.

As illustrated and discussed further below, a second rotating member 304-2, such as a pully, is coupled to the spinning lens assembly 208 such that the spinning lens assembly 208 rotates with rotations of the second rotating member 304-2. In the illustrated example, the first rotating member 304-1 and the second rotating member 304-2 may be attached by a flexible belt 305 so that the rotation of the first rotating member 304-1 by the shaft 306 and motor 302 will cause rotation of the second rotating member 304-2, which in turn rotates the spinning lens assembly 208 positioned within the substantially circular opening 207. In some implementations, the first rotating member 304-1 may be of a first size and the second rotating member 304-2 may be of a second size that is larger than the first size, thereby increasing the RPM of the spinning lens assembly 208 when rotated. Altering the size of pullies of a pully system to increase or decrease the RPMs of one pully with respect to the other pully is known in the art and need not be discussed in detail herein.

The motor 302 may be configured to operate at different speeds. Alternatively, the motor 302 may be binary and either engaged and rotating the shaft 306 or disengaged and not rotating the shaft 306. Any speed or range of motor RPMs may be utilized with the disclosed implementations, provided that the motor RPMs result in spinning lens assembly RPMs that are sufficient to expel substances, such as moisture or water off a surface of the spinning lens assembly 208.

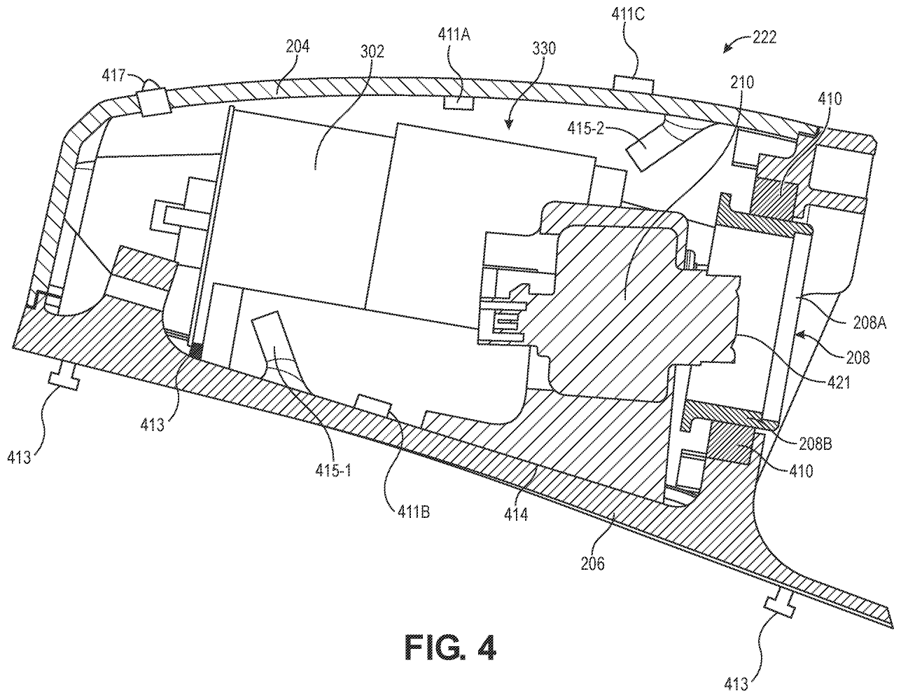

FIG. 4 is an example side section view of an example apparatus 222 that includes a motor 302, an imaging element 210, and a spinning lens assembly 208 that is rotated using one or more pullies, in accordance with described implementations.

In the illustrated example, the spinning lens assembly 208 includes a twenty millimeter circular ultraviolet (“UV”) lens filter 208A that may be screwed into, or otherwise attached to a barrel 208B of the spinning lens assembly 208. In other implementations, the lens 208A may be larger or smaller and/or include different filter characteristics. Likewise, the lens 208A may have a substantially flat surface, a convex surface, or a concave surface. In some implementations, a convex lens 208A may be utilized to further aid in the evacuation of water from the surface of the lens 208A. In some implementations, the lens 208A may be interchangeable.

The barrel 208B of the spinning lens assembly 208 may be pressure fit into the substantially circular opening 207 and held into place with bearings 410. The bearings 410, which may extend around the substantially circular opening, secure the barrel 208B of the spinning lens assembly 208 into the substantially circular opening 207 and allow the barrel 208B to rotate within the substantially circular opening 207 and also prohibit substances, such as water from entering through the substantially circular opening 207 into the interior 330 of the apparatus 222. A bearing, as used herein, is any type of assembly, such as a pressure bearing, ball bearings positioned within grooves, etc., that may be utilized to affix the spinning lens assembly 208 within the substantially circular opening 207 and allow the spinning lens assembly 208 to rotate within the substantially circular opening.

As discussed above, the imaging element 210 is positioned within the interior 330 of the apparatus 222 so that the view of the imaging element 210 is through the substantially circular opening 207 and the spinning lens assembly 208. In some implementations, the imaging element 210 may be affixed to the base surface 206 such that the imaging element lens 421 is aligned parallel with the lens 208A of the spinning lens assembly 208. In other implementations, such as the implementation illustrated in FIG. 4, the imaging element 210 may be affixed to the base surface 206 such that the imaging element lens 421 is at an angle with respect to the lens 208A of the spinning lens assembly 208. Accordingly, when the apparatus 222 is mounted to a vehicle, such as the hood of a vehicle, which may be sloped downward, the imaging element 210 may be in a substantially horizontal position and the lens 208A of the spinning lens assembly 208 may be oriented downward, as illustrated. Orienting the lens 208A of the spinning lens assembly 208 in a downward direction when mounted to a vehicle, in addition to the hoods, may aid in keeping substances, such as rain, off of the lens 208A.

In some implementations, one or more fans 415-1, 415-2 may also be positioned within the interior 330 of the housing of the apparatus 222 to increase airflow within the interior 330. For example, a first fan 415-1 may be affixed to the base surface 206 and positioned within the interior 330 to direct airflow toward the imaging element 210 to reduce heat buildup by the imaging element 210. A second fan 415-2 may be affixed to the interior 330 of the perimeter surface 204 and oriented to direct airflow toward the spinning lens assembly 208 to reduce potential buildup of condensation on the lens 208A of the spinning lens assembly 208.

Any number of fans 415-1, 415-2 may be included within the interior 330 of the housing of the apparatus 222. For example, a third fan may be positioned to direct airflow toward the motor 302. In some implementations, the fans 415-1, 415-2 may be active any time the imaging element 210 is active or anytime the vehicle 100 is active. In other implementations, the fans may operate on a timer or in response to a temperature sensor. For example, a temperature sensor may monitor a temperature differential between the interior 330 of the apparatus 222 and air that is outside of the apparatus 222 and activate the fans when the temperature differential exceeds a defined amount. In still another example, the fans may be manually activated, etc.

In some implementations, one or more sensors 411A, 411B, 411C, etc., may also be included on the interior of the apparatus, such as sensors 411A, 411B, and/or on the exterior of the apparatus 222, such as sensor 411C. Any of a variety of sensors may be utilized with the disclosed implementations. For example, and as discussed above, the sensors 411A and 411C may be temperature sensors and a differential temperature between the interior temperature and the exterior temperature may be monitored and the fans 415-1, 415-2 activated/deactivated, based on the temperature differential. In other implementations, the sensors 411A, 411B, 411C may be humidity sensors, pressure sensor, moisture sensors, vibration sensors, etc.

In some implementations, one or more vibration dampeners 413 may also be included in or on the apparatus. For example, one or more vibration dampeners 413 may be affixed between the motor 302 and the housing to dampen vibrations generated by the motor 302. In other examples, vibration dampeners 413 may be affixed between the apparatus 222 and a vehicle to which the apparatus is attached, thereby dampening vibrations between the apparatus 222 and the vehicle. In still other examples, one or more vibration dampeners may be affixed between the imaging element 210 and the apparatus 222 to still further dampen vibrations and stabilize the imaging element 210.

Increased airflow may aid in the reduction of any moisture buildup or condensation forming within the interior 330 of the housing. Operation of both the imaging element 210 and the motor 302 within the interior 330 of the housing may increase the temperature within the interior 330 of the housing to a point where condensation may form within the interior of the housing. To maintain or decrease the temperature within the interior of the housing, fans 415 and/or one or more heat sinks 414 may be included to evacuate heat from the interior of the housing and/or to circulate the air. For example, some, or all of the base surfaces 206 may include one or more heat sinks 414 that connect between the imaging element 210 and/or the motor 302 and an exterior of the housing and operate to evacuate heat from the imaging element 210 and/or motor 302 from the interior of the housing. Still further, in some implementations, the perimeter surface 204 may include one or more pressure valves 417 to regulate any pressure differentials between the exterior of the apparatus 222 and the interior 330 of the apparatus 222.

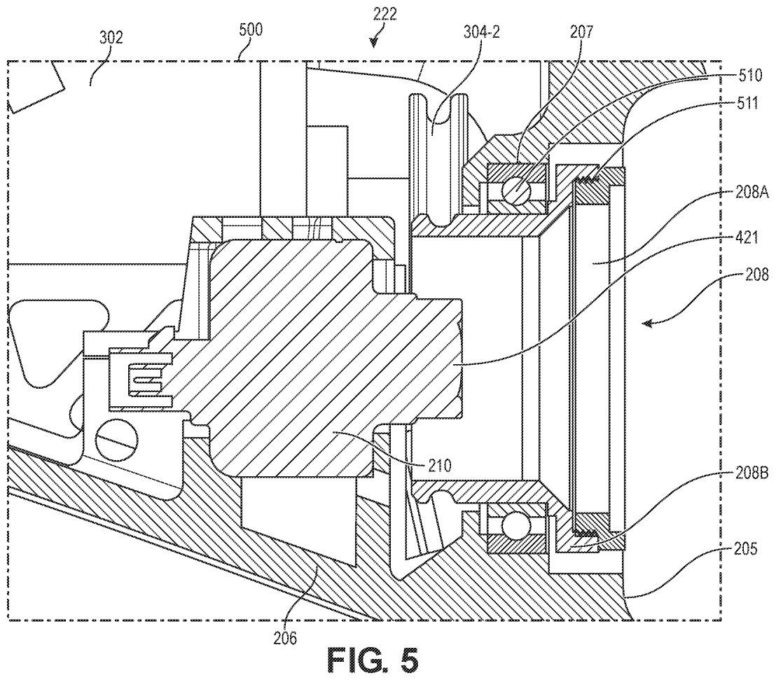

FIG. 5 is another example side sectional view 500 of an example apparatus 222 that includes a motor 302, an imaging element 210, such as a camera, and a spinning lens assembly 208 that is rotated using one or more pullies, in accordance with described implementations.

In comparison to FIG. 4, the imaging element 210 illustrated in FIG. 5 is affixed to the base surface 206 such that the imaging element lens 421 is aligned or substantially parallel with the lens 208A of the spinning lens assembly 208.

FIG. 5 also illustrates additional details of the bearing 510 that enables a friction fit between the barrel 208B of the spinning lens assembly 208 and the substantially circular opening 207 of the face surface 205 of the perimeter surface 204 of the housing of the apparatus 222. As discussed, the bearings 510 may extend around the substantially circular opening 207 and provide a friction fit into recesses or grooves of the barrel 208B of the spinning lens assembly 208, thereby rotatably securing the spinning lens assembly 208 within the substantially circular opening 207 and prohibiting substances (e.g., rain, snow, ice, mud, dirt, dust) from entering the interior of the housing through the substantially circular opening 207.

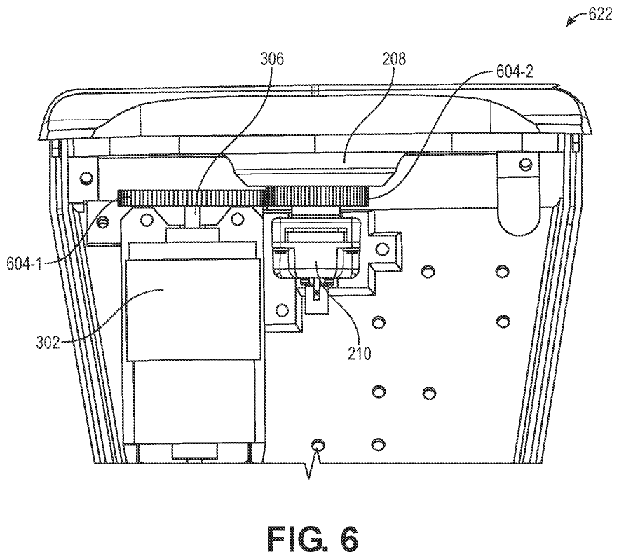

FIG. 6 is another example illustration of an interior of an apparatus 622 that includes a motor 302, an imaging element 210, such as a camera, and a spinning lens assembly 208 that is rotated using gears 604-1, 604-2, in accordance with described implementations.

The example illustration presented in FIG. 6 is comparable to the example illustration presented in FIG. 5 and discussed above except, in the implementation discussed with respect to FIG. 6, rather than pullies and a flexible belt coupling to the motor 302 and the spinning lens assembly 208 to enable rotation of the spinning lens assembly 208 when the motor 302 is activated, a series of gears 604-1, 604-2 are utilized. For example, a first rotating member 604-1 in the form of a first gear is coupled to the shaft 306 of the motor 302 and is rotated by the shaft 306 when the motor 302 rotates the shaft 306. Likewise, a second rotating member 604-2 in the form of a second gear, is coupled to, and rotates the spinning lens assembly 208. In this example, the gears of the second rotating member 604-2 mate with, and are turned by the gears of the first rotating member 604-1. When the motor 302 is engaged and rotates the shaft 306, the first rotating member 604-1 is rotated by the shaft 306, engages the gears of the second rotating member 604-2, and rotates the second rotating member along with the spinning lens assembly 208, thereby causing any substance on the surface of the lens 208A of the spinning lens assembly 208 to be evacuated from the surface of the lens 208A.

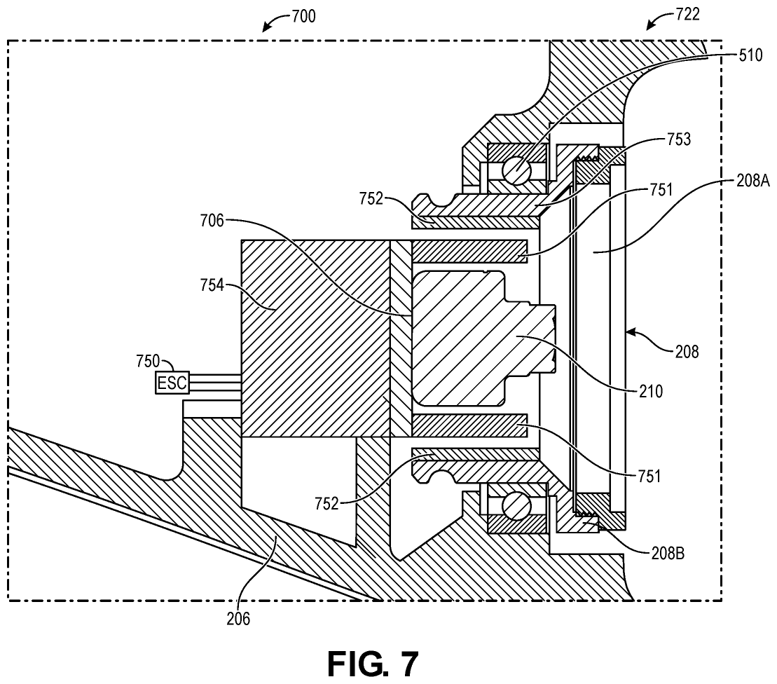

FIG. 7 is another side sectional view of an example apparatus 722 in which the imaging element 210 is positioned within an interior of a motor 706 that rotates the spinning lens assembly 208, in accordance with described implementations.

In the illustrated example, the motor is a brushless direct current (“DC”) motor, the imaging element 210 is surrounded by the stator of the brushless DC motor, and the rotor, which surrounds the stator and is rotated by the stator, is coupled to, and rotates the spinning lens assembly 208, also known as an out-runner brushless DC motor. In other implementations, the brushless DC motor may be an in-runner brushless DC motor in which the imaging element 210 is surrounded by the rotor of the brushless DC rotor and the rotor may be coupled to and rotate the spinning lens assembly. In such a configuration, the stator of the motor may be affixed to the housing of the apparatus and surround the rotor of the in-runner brushless DC motor. In other examples, other types of motors that enable positioning of the imaging element within the interior of the motor and rotation of the spinning lens assembly may be utilized with the disclosed implementations.

As is known, a brushless DC motor includes a base plate 706, a stator, and a rotor. In this example, the base plate 706 is affixed to the base surface 206 of the housing. In some implementations, the stator may be directly coupled to the base surface 206. In other implementations, the base plate 706 may be attached to a heat sink 754 that is coupled to or included in the base surface 206 of the housing, thereby dissipating heat away from the motor and the imaging element 210. For an out-runner brushless DC motor, the stator, which includes any number of electromagnetic windings 751, may be attached to the base plate 706 of the motor. For an in-runner brushless DC motor, the rotor may be positioned around the imaging element and affixed to the spinning lens assembly. In addition, rather than a small opening through the center of the stator or rotor, depending on the motor configuration, through which a shaft 306 of the motor typically extends, in the disclosed implementation, the opening is enlarged to a size sufficient to house the imaging element 210, or at least a portion of the imaging element 210, such that the imaging element 210 is positioned within the interior of, and at least partially surrounded by the electromagnetic windings 751 of the stator or the magnets of the rotor. In implementations that utilize an in-runner brushless DC motor, the stator, rather than being affixed to the base plate, may be affixed to the perimeter of the housing.

As noted above, to stabilize the rotor, the rotor may be affixed to the spinning lens assembly 208. As discussed above, in the disclosed implementations, the spinning lens assembly 208 may be rotatably affixed to the substantially circular opening in the perimeter surface 204 of the housing through the use of bearings 510.

The motor may be controlled by an electronic speed controller (“ESC”) 750 which may receive signals from any of a variety of inputs (e.g., sensors, switches), as discussed above.

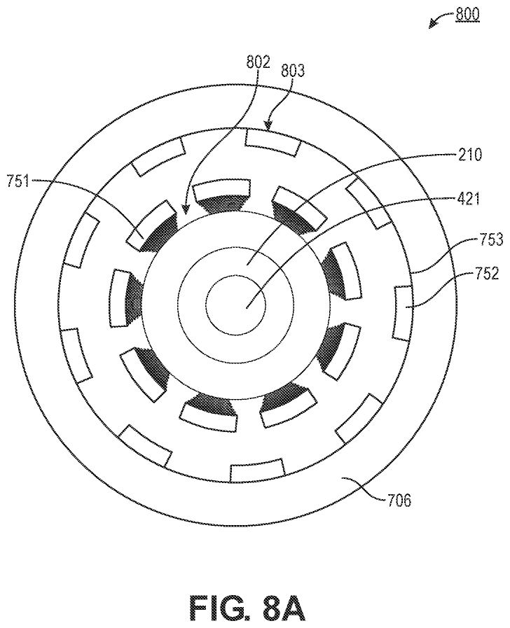

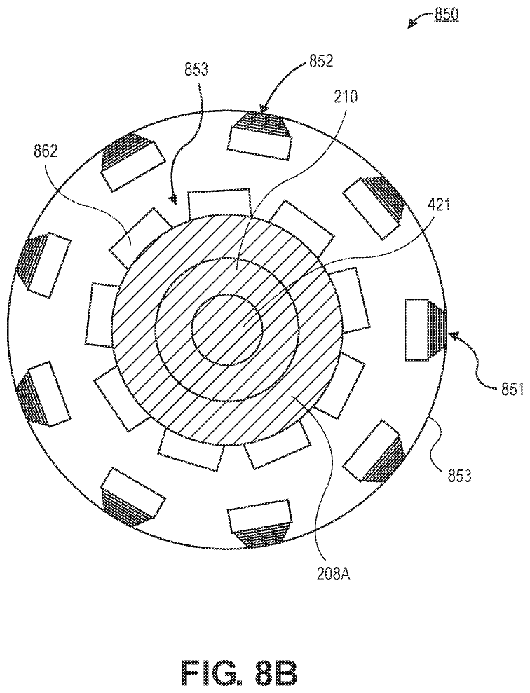

Referring briefly to FIG. 8A, illustrated is a face on view of an out-runner brushless DC motor 800 and imaging element 210 discussed with respect to FIG. 7, in accordance with described implementations.

As illustrated, the imaging element 210, which includes an imaging element lens 421, is positioned in the center of the stator 802 and surrounded by the electromagnetic windings 751 of the stator 802. The stator 802 and the imaging element 210 may be coupled to the base plate 706.

The rotor 803, which includes a cylindrical housing 753 and a series of permanent magnets 752 affixed to the inside of the cylindrical housing 753 are positioned around and surround the stator 802, as is typical for an out-runner brushless DC motor. Because the rotor 803 is affixed to the spinning lens assembly 208, which is secured to the housing 753 by bearings 510, as discussed above, the shaft that typically extends from the rotor 803 through the housing 753 may be eliminated, because the spinning lens assembly 208 secures and stabilizes the rotor 803.

In comparison and referring to FIG. 8B, illustrated is a face on view of an in-runner brushless DC motor 850 and imaging element 210, in accordance with described implementations.

As illustrated, the imaging element 210, which includes an imaging element lens 421, is positioned in the center of the rotor 853 and surrounded by the permanent magnets 862 of the rotor 853. In this example, the imaging element 210 may be coupled to a base plate and the rotor 853 may be coupled to the spinning lens assembly 208A.

The stator 852, which includes a series of electromagnets 851 affixed to the inside of the cylindrical housing 853 are positioned around and surround the rotor 853, as is typical for an in-runner brushless DC motor. Likewise, the stator 852 may be affixed to and stabilized by the housing of the apparatus and/or affixed to the base plate of the motor.

With the configuration of the motor and imaging element discussed with respect to FIG. 7 and FIG. 8A or FIG. 8B, when the motor 800 is engaged, the rotor 803, which is directly attached to the spinning lens assembly 208, rotates the spinning lens assembly 208 such that any substance on the surface of the lens 208A of the spinning lens assembly 208 is evacuated. Likewise, by positioning the imaging element 210 within the opening of the interior of the stator 802 of the motor 800, there is no need for a gear or pully mechanism between the motor shaft 306 and the spinning lens assembly 208, because the rotor 803 of the motor 800 can be directly connected to the spinning lens assembly 208. As a result, the entire size of the apparatus 800 can be reduced and simplified.

Each of the motors discussed above with respect to FIGS. 2-8 may be controlled by a motor controller, such as an ESC or other motor controller. The motor controller may receive an input signal, for example from a switch or sensor, and activate or deactivate the motor, as discussed above. In other implementations, the input signal may be provided directly to the motor to cause the motor to activate or deactivate.

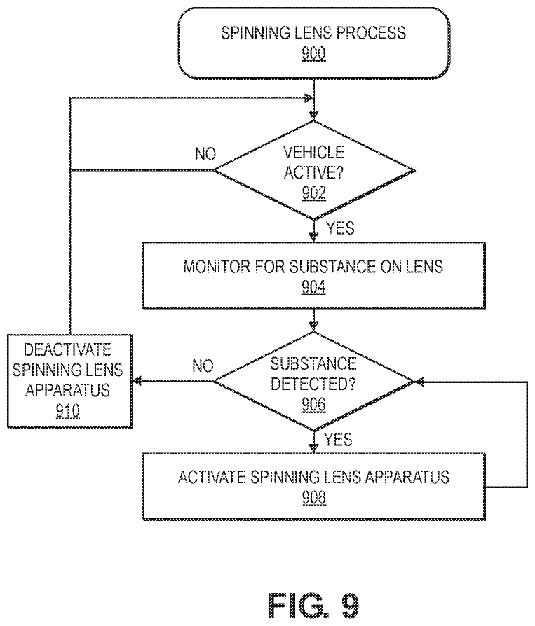

FIG. 9 is an example spinning lens process 900, in accordance with described implementations. The example process 900 may be performed locally at the vehicle and/or by a component of the apparatus. Alternatively, the example process 900 may be performed by computing resources, such as computing resources 103 (FIG. 1), by the teledriving program(s) 150, etc.

The example process 900 begins by determining if the vehicle to which the apparatus is attached is active, as in 902. Active may mean whether the vehicle is in motion, whether the vehicle is powered, etc. If it is determined that that vehicle is not active, the example process 900 returns to decision block 902 and continues.

Upon determination that the vehicle is active, the example process may monitor for a substance in contact with the lens of the spinning lens assembly, as in 904. As discussed above, monitoring may include monitoring for a signal from a moisture sensor that is included on the vehicle and/or included on the apparatus, monitoring for a signal from a switch that is included in the vehicle and/or that is remote from the vehicle, processing image data generated by the imaging element of the apparatus to determine if a substance is potentially present on the lens of the spinning lens assembly that is causing an object represented in the image data to appear obscured or obstructed, etc.

As the example process 900 monitors for a substance on the lens, a determination is made as to whether a substance has potentially been detected on the lens, as in 906. If it is determined that a substance has potentially been detected, the motor of the spinning lens is activated, thereby causing the spinning lens assembly to rotate such that any substance on the surface of the lens of the spinning lens assembly is evacuated from the surface of the lens, as in 908. After activating the motor, the example process returns to block 906 and continues. If it is determined at decision block 906 that moisture is not detected, or no longer detected, at block 910, the motor of the apparatus may be deactivated, if it was active, and the example process may return to decision block 902 and continue.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers, communications, automation, teledriving, etc., should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details disclosed herein. Moreover, with respect to the one or more methods or processes of the present disclosure described herein, including but not limited to the flow chart shown in FIG. 9, orders in which such methods or processes are presented are not intended to be construed as any limitation on the claimed inventions, and any number of the method or process steps or boxes described herein can be combined in any order and/or in parallel to implement the methods or processes described herein, and/or omitted. Also, the drawings herein are not drawn to scale.

Aspects of the disclosed apparatus, methods, and systems may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage media may be implemented by a volatile computer memory, non-volatile computer memory, hard drive, solid-state memory, flash drive, removable disk, and/or other media. In addition, components of one or more of the processes may be implemented in firmware or hardware.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially,” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative implementations thereof, the foregoing and various other additions and omissions may be made therein and thereto without departing from the spirit and scope of the present disclosure.

What is claimed is:

1. An apparatus, comprising:
a housing, including:
a base surface configured to be attached to a vehicle; and
a perimeter surface that couples to the base surface to form an interior between the base surface and the perimeter surface, the perimeter surface having a substantially cylindrical opening;
an imaging element affixed within an interior of the housing and oriented such that a field of view of the imaging element is through the substantially cylindrical opening;
a motor having a shaft that is rotatable by the motor, the motor affixed within the interior of the housing;
a first rotating member attached to the shaft and rotated by the shaft when the shaft is rotated by the motor;
a spinning lens assembly rotatably coupled to, and positioned within, the substantially cylindrical opening;
a second rotating member attached to the spinning lens assembly and operable to rotate the spinning lens assembly, wherein the second rotating member is rotated by the first rotating member when the first rotating member is rotated by the shaft; and
wherein:
when the motor is engaged by the motor controller, the motor causes the shaft to rotate, which causes the first rotating member, the second rotating member, and the spinning lens assembly to rotate, wherein the spinning lens assembly rotates at a revolutions per minute that causes a water to be displaced off of a surface of a lens of the spinning lens assembly.

2. The apparatus of claim 1, further comprising:
a flexible belt connected with the first rotating member and the second rotating member; and
wherein:
the first rotating member is a first pully; and
the second rotating member is a second pully.

3. The apparatus of claim 1, wherein:
the first rotating member is a first gear;
the second rotating member is a second gear; and
the first gear engages and rotates the second gear when the first gear is rotated by the shaft of the motor.

4. The apparatus of claim 1, further comprising:
a compression bearing disposed between the housing and the spinning lens assembly, wherein the compression bearing:
holds the spinning lens assembly within the substantially cylindrical opening;
allows the spinning lens assembly to rotate within the substantially cylindrical opening; and
substantially prevents the water from entering the housing between the spinning lens assembly and the substantially cylindrical opening.

5. The apparatus of claim 1, wherein the surface of a lens of the spinning lens assembly is convex.

6. An apparatus, comprising:
a housing, including:
a base surface configured to be attached to a vehicle; and
a perimeter surface that couples to the base surface to form an interior between the base surface and the perimeter surface, the perimeter surface having a substantially cylindrical opening;
an imaging element positioned within the interior of the housing and oriented such that a field of view of the imaging element is through the substantially cylindrical opening;
a motor affixed within the interior of the housing and having a rotating member that rotates when the motor is engaged; and
a spinning lens assembly rotatably coupled to, and positioned within the substantially cylindrical opening, the spinning lens assembly rotated by the rotating member of the motor at a revolutions per minute (“RPM”) that is at least sufficient to remove a substance from a surface of a lens of the spinning lens assembly when the spinning lens assembly is rotated so that the field of view of the imaging element is not obstructed or obscured by the substance.

7. The apparatus of claim 6, further comprising:
at least one sensor, wherein the at least one sensor is at least one of a pressure sensor, a humidity sensor, or a temperature sensor.

8. The apparatus of claim 6, wherein:
the motor is a brushless motor that includes a stator and a rotor that rotates about the stator;
the rotating member is the rotor; and
the imaging element is positioned within, and at least partially encompassed by the stator of the motor.

9. The apparatus of claim 8, further comprising:
a compression bearing disposed between the housing and the spinning lens assembly, wherein;
the spinning lens assembly is coupled to the rotor; and
the compression bearing holds the spinning lens assembly within the substantially cylindrical opening such that the spinning lens assembly is rotatable within the substantially cylindrical housing and the rotor is rotatable about the stator.

10. The apparatus of claim 6, further comprising:
a second rotating member coupled to the spinning lens assembly that is rotated by the rotating member when the motor is engaged.

11. The apparatus of claim 10, wherein:
the rotating member is a first pully;
the second rotating member is a second pully; and
the first pully and the second pully are connected by a flexible belt such that the flexible belt causes the second pully to rotate in response to a rotation of the first pully.

12. The apparatus of claim 6, further comprising:
at least one fan positioned within the interior of the housing to cause airflow within the interior of the housing.

13. The apparatus of claim 6, further comprising:
at least one heat sink positioned to evacuate heat generated by at least one of the motor or the imaging element from the interior of the housing.

14. The apparatus of claim 6, further comprising:
a motor controller operable to selectively engage and disengage the motor.

15. The apparatus of claim 14, wherein:
the motor controller engages the motor in response to receiving a signal indicative of the substance being present and potentially in contact with the surface of a lens of the spinning lens assembly.

16. The apparatus of claim 6, further comprising:
a compression bearing disposed between the housing and the spinning lens assembly, wherein the compression bearing:
holds the spinning lens assembly within the substantially cylindrical opening;
allows the spinning lens assembly to rotate within the substantially cylindrical opening; and
substantially prevents a substance from entering the housing between the spinning lens assembly and the substantially cylindrical opening.

17. An apparatus, comprising:
a housing, including:
a base surface configured to be attached to a vehicle; and
a perimeter surface that couples to the base surface to form an interior between the base surface and the perimeter surface, the perimeter surface having a substantially cylindrical opening;
an imaging element positioned within the interior of the housing and oriented such that a field of view of the imaging element is through the substantially cylindrical opening;
a motor affixed within the interior of the housing; and
a spinning lens assembly positioned within the substantially cylindrical opening, the spinning lens assembly rotatable by the motor.

18. The apparatus of claim 17, further comprising:
a heat sink coupled to the housing and operable to evacuate heat from the interior of the housing.

19. The apparatus of claim 17, wherein the motor is operable to be activated to rotate the spinning lens assembly in response to at least one of:
a first signal from a moisture sensor coupled to the vehicle; or
a second signal from a switch.

20. The apparatus of claim 19, wherein the switch is remote from the vehicle and operable by a teledriver that is remote from the vehicle and interacts with the vehicle.
